(19) United States
(12) Patent Application Publication
(10) Pub. No.: US 2005/0214434 A1
(43) Pub. Date: Sep. 29, 2005

(54) Preparation method of the conjugated linoleic acid diglycerides

(76) Inventors: Dong-Hun Yoon, Seoul (KR); Gi-Wang Han, Incheon (KR); Soon-Gi Hong, Cheongju-si (KR); Young-Ho Lee, Cheongju-si (KR)

Correspondence Address: BIRCH STEWART KOLASCH & BIRCH, PO BOX 747, FALLS CHURCH, VA, 22040-0747, US

(21) Appl. No.: 10/510,700

(22) PCT Filed: Mar. 12, 2004
(86) PCT No.: PCT/KR04/00511

§ 371 Date: Oct. 8, 2004

(30) Foreign Application Priority Data
Apr. 25, 2003 (KR) 10-2003-0026515
Mar. 9, 2004 (KR) 10-2004-0015668

(51) Int. Cl. A23D 7/00

(52) U.S. Cl. 426/601

(57) ABSTRACT

A fat composition of high purity diglyceride containing conjugated linoleic acid and a preparation method thereof are provided. The fat composition comprises 85% to 99.9% by weight of diglyceride containing 0.1 to 80% by weight of conjugated linoleic acid, and the balance being monoglyceride, triglyceride or a mixture thereof. The fat composition can be used in highly functional food additives owing to conjugated linoleic acid having various functions of effecting anti-cancer activity, reducing human body fat, enhancing immunogenicity, and preventing and/or treating diabetes, and can be simply prepared at a high production yield.

### TECHNICAL FIELD

The present invention relates to a fat composition of high purity diglyceride comprising conjugated linoleic acid and a preparation method of the same. More particularly, the present invention relates to a fat composition of high purity diglyceride comprising conjugated linoleic acid and a preparation method thereof, which is simplified and provides a high production yield, while exhibiting high functionality when the conjugated linoleic acid or its isomer having various functions of effecting anti-cancer activity, reducing human body fat, enhancing immunogenicity, and preventing and/or treating diabetes, is bonded thereto.

### BACKGROUND ART

Lipases are enzymes which hydrolyze fats and oils or esters of fatty acids. However, it is known that, under certain conditions, lipases cause an esterification reaction and thereby glycerides or esters can be synthesized from a fatty acid and glycerol or from a fatty acid and an alcohol (J. Gen. Appl. Microbiol., 10, 13-22, 1964; Proc. IV IFS: Ferment. Technol. Today, 315-320, 1972, issued by Society of Fermentation Technology Japan; Biochim. Biophys. Acta, 489, 415-422, 1977; Bull.

Glycerides synthesized by an esterification reaction are classified into monoglycerides (MG), diglycerides (1,2-DG, 1,3-DG, 2,3-DG), and triglycerides (TG) according to the degree of substitution of hydroxyl group.

Diglycerides are fat compositions in which fatty acid(s) and 1-, 2-, or 1- and 3-position glycerin(s) are bonded by an esterification reaction and are classified differently from ordinary fats called triglycerides.

Recently, it has been reported that diglyceride has substantially the same digestion and absorption mechanisms as ordinary neutral fat and does not cause adverse physiological effects when ingested, such as a rise in the neutral fat level in human serum or accumulation of body fat, because little diglyceride is resynthesized to become neutral fat. Accordingly, research into preparation methods of such diglyceride is continuously being carried out.

One of those preparation methods of diglyceride is disclosed in Japanese Patent Laid-Open Publication No. Hei 6-343481, in which solid fat is reacted with a lipase derived from glycerin or microorganisms of genera Pseudomonas, yielding 85% diglyceride. However, this method has drawbacks that formation of the solid fat requires a room temperature condition and it is quite difficult to obtain diglyceride having a purity of higher than 85% from liquid fat.

Japanese Patent Laid-Open Publication Nos. showa 64-71495 and hei 11-123097 disclose methods of preparing fat compositions comprising diglyceride having a purity of 80%, by hydrolyzing a fat into a fatty acid and glycerin using a 1,3-positionally specific lipase, and resynthesizing the hydrolyzed fatty acid and glycerin. These methods, however, involve quite a complex mechanism, that is, hydrolyzed glycerin should be first dehydrated before being synthesized with fatty acid.

To overcome the aforementioned problems, a preparation method of a fat composition containing diglyceride of a purity of higher than 60% has been proposed in Korean Patent Application No. 2001-0002974, in which water and a 1,3-positionally specific lipase or a nonspecific lipase are used. However, this technique also presents some problems that the content of free fatty acids may increase due to a side reaction occurring after the reaction, i.e., hydrolysis of fatty acids in the diglyceride having a purity of higher than 60% in the presence of water, requiring an additional step of removing the free fatty acids. Also, byproducts containing 40% of free fatty acids should be further processed for filtration.

It would, therefore, be highly demanded to conduct research into preparation methods of a high purity diglyceride fat composition, which is simplified and provides a high production yield.

Conjugated linoleic acid (CLA) is a conjugated isomer of linoleic acid (LA), which is an essential fatty acid that is a naturally occurring fatty acid found in the breast milk or muscle of ruminants in a trace amount. CLA is a general term used to name positional and geometric isomers of linoleic acid having conjugated double bonds in cis- or trans-configuration. Among those CLA isomers, physiologically functional cis-9, trans-11 octadecadienoic acid and trans-10, cis-12 octadecadienoic acid are specifically referred to as the CLA. The CLA is excellent in reducing incidence of sclerosis of the artery (Artery, 1997, 22:266-277), enhancing immunogenicity (J. Nut., 1999, 129:32-38) and anti-cancer activity (Anticancer research, 1997, 17:969-973), promoting growth (J. Nut., 2000, 130:2981-2989) and therapeutic effects with respect to diabetes or other diseases. Further, the CLA has been reported to suppress obesity by reducing body fat (Am. J. Physiol., 1998, 275:R667-R672). By virtue of such properties, the CLA can be advantageously used as the effective component of functional food and pharmaceutical products.

### DISCLOSURE OF THE INVENTION

To solve the above problems, the present invention provides a fat composition of high purity diglyceride comprising conjugated linoleic acid having functions of effecting anti-cancer activity, reducing human body fat, enhancing immunogenicity, and preventing and/or treating diabetes.

Also, the present invention provides a method of preparing a fat composition of high purity diglyceride comprising conjugated linoleic acid having functions of effecting anti-cancer activity, reducing human body fat, enhancing immunogenicity, and preventing and/or treating diabetes, the preparation process of which is simple, and which provides a high production yield.

The present invention further provides cosmetic emulsifiers, pharmaceutical emulsifiers, or highly functional food additives having functions of effecting anti-cancer activity, reducing human body fat, enhancing immunogenicity, and preventing and/or treating diabetes.

In an aspect of the present invention, there is provided a fat composition of high purity diglyceride comprising 85% to 99.9% by weight of diglyceride containing 0.1 to 80% by weight of conjugated linoleic acid, and the balance being monoglyceride, triglyceride or a mixture thereof.

In another aspect of the present invention, there is provided a method of preparing a fat composition of high purity diglyceride, the method comprising: mixing monoglyceride, conjugated linoleic acid; and fat, fatty acid or a mixture thereof, and stirring the resulting mixture at 10 to 200 rpm; and subjecting the stirred mixture to an transesterification at a temperature of 200 to 250° C. under reduced pressure of 0.001 to 0.5 torr for 1 to 10 hours.

In still another aspect of the present invention, there is provided a method of preparing a fat composition of high purity diglyceride, the method comprising: mixing monoglyceride, conjugated linoleic acid; and a lipase, and stirring the resulting mixture at 10 to 200 rpm; and subjecting the stirred mixture to an transesterification at a temperature of 30 to 60° C. under reduced pressure of 0.001 to 0.5 torr for 1 to 10 hours.

In still further aspect of the present invention, there is provided cosmetic emulsifiers, pharmaceutical emulsifiers or highly functional food additives comprising the fat composition of high purity diglyceride containing conjugated linoleic acid prepared by the above-described method.

### BEST MODE FOR CARRYING OUT THE INVENTION

The present invention will now be described in detail.

The present inventors conducted earnest studies based on the ideas that conjugated linoleic acid had functions of effecting anti-cancer activity, reducing human body fat, enhancing immunogenicity, and preventing and/or treating diabetes and that the fat composition of high purity diglyceride comprising the conjugated linoleic acid would be advantageously useful as cosmetic emulsifiers, pharmaceutical emulsifiers, or highly functional food additives. The present invention has been completed on the basis of the above finding.

Also, as a result of the present inventors' studies of simplified, high-yield preparation methods of a fat composition of high purity diglyceride, it was discovered that the fat composition of high purity diglyceride having functions of effecting anti-cancer activity, reducing human body fat, enhancing immunogenicity, and preventing and/or treating diabetes could be prepared by a simplified preparation method, comprising mixing monoglyceride, conjugated linoleic acid, fat, fatty acid or a mixture thereof and stirring the mixture at a speed of 10 to 200 rpm, and subjecting the stirred mixture to an transesterification at 200 to 250° C. under reduced pressure of 0.001 to 0.5 torr for 1 to 10 hours. Alternatively, the preparation method may comprise mixing monoglyceride, conjugated linoleic acid and a lipase and stirring at a speed of 10 to 200 rpm, and subjecting the stirred mixture to an transesterification at 30 to 60° C. under reduced pressure of 0.001 to 0.5 torr for 1 to 10 hours. The present inventors have completed the present invention based on such discovery.

In the fat composition of high purity diglyceride containing conjugated linoleic acid according to the present invention, the conjugated linoleic acid is preferably contained in the diglyceride in an amount of 0.1 to 80%. The reason of specifically defining the preferred content of conjugated linoleic acid will now be described. When the content of conjugated linoleic acid is less than 0.1%, effects of the fat composition are negligible in view of functions of effecting anti-cancer activity, reducing human body fat, enhancing immunogenicity, and preventing and/or treating diabetes. When the content of conjugated linoleic acid is greater than 80%, the excess gives rise to a high cost of conjugated linoleic acid, increasing the preparation cost of high-purity diglyceride, which is not effective economically.

The preparation method of the fat composition of diglyceride containing conjugated linoleic acid proposed by the present inventors can be generally divided into two categories.

The first category is to use fat, fatty acid or a mixture thereof: Monoglyceride, conjugated linoleic acid, and fat, fatty acid or a mixture thereof are mixed and stirred, and the stirred mixture is subjected to an transesterification.

(a) Mixing and Stirring Monoglyceride, Conjugated Linoleic Acid, and Fat, Fatty Acid or a Mixture Thereof

The reaction conditions will now be described in more detail. First, monoglyceride, conjugated linoleic acid, and fat, fatty acid or a mixture thereof are mixed and stirred. In the stirring step, the mixing of monoglyceride, conjugated linoleic acid, and fat, fatty acid or a mixture thereof is preferably performed by adding 35 to 65 parts by weight of conjugated linoleic acid and 20 to 80 parts by weight of fat, fatty acid or a mixture thereof, based on 100 parts by weight of monoglyceride.

In the mixture, the molar ratio of monoglyceride to fat, fatty acid or a mixture thereof is preferably in the range of 6:4 to 8:2.

The resulting mixture of monoglyceride, conjugated linoleic acid, and fat, fatty acid or a mixture thereof is preferably stirred at a speed of 10 to 200 rpm. When the stirring speed is less than 10 rpm, the stirring power is so weak that the reaction may be retarded. When the stirring speed exceeds 200 rpm, the excess may result in degradation in product quality such as coloring.

(b) Subjecting Stirred Mixture to Transesterification

The transesterification of the stirred mixture is preferably carried out at 200 to 250° C. under reduced pressure of 0.001 to 0.5 torr for 1 to 10 hours. The temperature of the transesterification is more preferably in a range of 200 to 230° C. When the temperature of the transesterification is lower than 200° C., the reaction speed is slow. When the temperature of the transesterification exceeds 250° C., the excess undesirably makes content control difficult. Also, when the reduced pressure is less than 0.001 torr, in addition to monoglyceride, diglyceride may also be dissolved during distillation. When the reduced pressure is greater than 0.5 torr, distillation of monoglyceride is difficult to achieve.

Examples of oils and fats useful in preparation of the fat composition of high purity diglyceride comprising conjugated linoleic acid include soybean oil, rapeseed oil, cotton-seed oil, corn oil, olive oil, palm oil, palm kernel oil, coconut oil, safflower oil and mixtures thereof. Examples of saturated or unsaturated fatty acids having 2 to 24 carbon atoms include oleic acid, soybean fatty acid, capric acid, lauric acid, myristic acid, palmitic acid, stearic acid, linolenic acid, docosahexaenoic acid (DHA), and mixtures thereof. They can be used alone, or in combination with two or more compounds.

The second category is to use a lipase: Monoglyceride, conjugated linoleic acid, and a lipase are mixed and stirred, and the stirred mixture is subjected to a transesterification, which will now be described in more detail.

(a) Mixing and Stirring Monoglyceride, Conjugated Linoleic Acid, and Lipase

In this step, monoglyceride, conjugated linoleic acid, and a lipase are mixed and stirred.

The conjugated linoleic acid can be prepared by isomerizing monoglyceride containing 1 to 80 parts by weight of linoleic acid based on 100 parts by weight of monoglyceride.

The conjugated linoleic acid in the mixture is preferably contained in an amount of 1 to 80 parts by weight, based on 100 parts by weight of monoglyceride. When the amount of the conjugated linoleic acid is less than 1 part, the functionality thereof may be lowered. When the amount of the conjugated linoleic acid is greater than 80 parts, the excess is not cost-effective.

The present invention is not limited to the use of any particular lipase, preferably lypozyme, 1, 3-positionally specific lipase, positionally non-specific lipase, or 1, 3-positionally specific rhizopus, more preferably 1,3-positionally specific or positionally non-specific lipase.

The lipase is preferably contained in an amount of 0.1 to 20 parts by weight based on 100 parts by weight of monoglyceride. When the content of the lipase is less than 0.1 parts by weight, the shortage gives rise in a noticeable reduction in the conversion rate. When the content of the lipase is greater than 20 parts by weight, the economic efficiency is undesirably lowered.

It is preferable that the monoglyceride, conjugated linoleic acid, and lipase are homogenized, followed by stirring at 10 to 200 rpm, more preferably at 150 rpm.

(b) Subjecting Stirred Mixture to Transesterification

The transesterification of the stirred mixture is preferably carried out at 40 to 80° C. at a stirring speed of 10 to 200 rpm for 1 to 10 hours. Preferably, the transesterification is carried out at a stirring speed of 10 to 200 rpm, more preferably 150 rpm, and at a temperature in a range of 30 to 60° C., more preferably 50° C. When the stirring speed is lower than 10 rpm, the stirring power is so weak that the reaction speed may be retarded. When the stirring speed exceeds 200 rpm, the excess gives rise to a fast, but uncontrollable, reaction. Also, when the reaction temperature is lower than 40° C., the reaction becomes slow. When the reaction temperature exceeds 80° C., the reaction is facilitated but enzymes or other reaction factor may be adversely affected by heat. Also, when the reaction time is shorter than 1 hour, the conversion efficiency is not high.

After performing the preparation method of the fat composition of high purity diglyceride containing conjugated linoleic acid by the above-described method divided into two categories, monoglyceride, triglyceride, or fatty acids contained in the fat composition are removed by molecular distillation, thereby acquiring a fat composition containing at least 80% by weight of diglyceride.

The thus-prepared fat composition according to the present invention preferably comprises 80 to 99.9% by weight of diglyceride containing 0.1 to 80% by weight of conjugated linoleic acid. Although a trace amount of triglyceride or monoglyceride may be contained in the fat composition, to increase the purity of diglyceride, further performing molecular distillation is preferred.

As described above, according to the present invention, the preparation process of a fat composition of diglyceride containing conjugated linoleic acid is simplified and a high production yield thereof can be provided. Also, when the conjugated linoleic acid having various functions of effecting anti-cancer activity, reducing human body fat, enhancing immunogenicity, and preventing and/or treating diabetes, is bonded to the diglyceride, the functionalities can be enhanced.

Also, the present invention provides cosmetic emulsifiers, pharmaceutical emulsifiers or highly functional food additives, particularly dietary food additives, comprising as an effective component fat composition of high purity diglyceride. The cosmetic emulsifiers, pharmaceutical emulsifiers or highly functional food additives, particularly dietary food additives advantageously exhibit various functions of effecting anti-cancer activity, reducing human body fat, enhancing immunogenicity, and preventing and/or treating diabetes.

A further understanding can be obtained by reference to certain preferred examples which are provided herein for purposes of illustration only and are not intended to be limiting unless otherwise specified.

### EXAMPLES

### Example 1

Into a 3 l round flask equipped with an stirrer were added 1300 g of monoglyceride, 20 g of conjugated linoleic acid and 5 g of lipase for mixing, stirred at a stirring speed of 150 rpm for solidifying, and reacted at 60° C. at a stirring speed of 150 rpm for 10 hours, thereby preparing a fat composition of diglyceride containing conjugated linoleic acid.

### Example 2

Into a 3 l round flask equipped with an stirrer were added 1200 g of monoglyceride, 40 g of conjugated linoleic acid and 5 g of lipase for mixing, stirred at a stirring speed of 150 rpm for solidifying, and reacted at 60° C. at a stirring speed of 150 rpm for 10 minutes, thereby preparing a fat composition of diglyceride containing conjugated linoleic acid.

### Example 3

Into a 3 l round flask equipped with an stirrer were added 1000 g of monoglyceride, 80 g of conjugated linoleic acid and 5 g of lipase for mixing, stirred at a stirring speed of 150 rpm for solidifying, and reacted at 60° C. at a stirring speed of 150 rpm for 2 hours, thereby preparing a fat composition of diglyceride containing conjugated linoleic acid.

### Example 4

Into a 3 l flask were added 30 g of monoglyceride, 3 g of soybean fatty acid, 2 g of oleic acid, 65 g of conjugated linoleic acid, and slowly stirred for reaction under reduced pressure for 1 hour until the temperature reached 250° C., followed by molecular distillation under reduced pressure of 0.04 torr at 250° C., giving a fat composition of diglyceride. Contents of monoglyceride, diglyceride, and triglyceride of the fat composition of diglyceride prepared in Example 4 and a content of conjugated linoleic acid bonded to the fat composition of diglyceride were measured and listed in Table 1.

TABLE 1

| | Content (% by weight) | |
|---|---|---|
| Monoglyceride | 0.5% | Conjugated linoleic |
| 1,2-diglyceride | 30% | acid 60% |
| 1,3-diglyceride | 54.6% | |
| Triglyceride | 14.9% | |

### Example 5

The fat compositions prepared in Examples 1 to 3 were subjected to molecular distillation using a diglyceride preparation processing system manufactured by Ilshin Emulsifier Co., Ltd., Korea until monoglyceride and triglyceride are all distillation, and contents of diglycerides, e.g., 1,2-diglyceride, 1,3-diglyceride, and conjugated linoleic acid bonded to diglyceride, were measured. The measurement results are shown in Table 2.

TABLE 2

| | Example 1 | | Example 2 | | Example 3 | |
|---|---|---|---|---|---|---|
| Monoglyceride | 1% | Conjugated | 0.5% | Conjugated | 0.3% | Conjugated |
| 1,2-diglyceride | 29% | linoleic acid | 30% | linoleic acid | 27% | linoleic acid |
| 1,3-diglyceride | 55.6% | 14.5% | 54.6% | 34% | 58% | 75.9% |
| Triglyceride | 14.4% | | 14.9% | | 14.7% | |

(Unit: % by weight)

### INDUSTRIAL APPLICABILITY

According to the present invention, the fat composition of high purity diglyceride can be simply prepared at a high production yield, while exhibiting high functionality when it is bonded to conjugated linoleic acid having functions of effecting anti-cancer activity, reducing human body fat, enhancing immunogenicity, and preventing and/or treating diabetes. The fat composition of high purity diglyceride according to the present invention can be used for cosmetic emulsifiers, pharmaceutical emulsifiers or dietary food additives as highly functional food additives having various functions of effecting anti-cancer activity, reducing human body fat, enhancing immunogenicity, and preventing and/or treating diabetes, because the fat composition is not digested and absorbed into the body as body fat.

1. A fat composition of high purity diglyceride comprising:
85% to 99.9% by weight of diglyceride containing 0.1 to 80% by weight of conjugated linoleic acid; and
the balance being monoglyceride, triglyceride or a mixture thereof.

2. A method of preparing a fat composition of high purity diglyceride containing conjugated linoleic acid, the method comprising:
mixing monoglyceride, conjugated linoleic acid, and fat, fatty acid or a mixture thereof and stirring the mixture at a speed of 10 to 200 rpm; and
subjecting the stirred mixture to an transesterification at 200 250° C. under reduced pressure of 0.001 to 0.5 torr for 1 to 10 hours.

3. The method of claim 2, wherein the molar ratio of monoglyceride to fat, fatty acid or a mixture thereof is preferably in the range of 6:4 to 8:2.

4. The method of claim 2, wherein the temperature of the transesterification is in a range of 200 to 230° C.

5. The method of claim 2, wherein the oil or fat is selected from the group consisting of soybean oil, rapeseed oil, cotton-seed oil, corn oil, olive oil, palm oil, palm kernel oil, coconut oil, safflower oil and mixtures thereof.

6. The method of claim 2, wherein the fatty acid is a saturated or unsaturated fatty acid having 2 to 24 carbon atoms selected form the group consisting of oleic acid, soybean fatty acid, capric acid, lauric acid, myristic acid, palmitic acid, stearic acid, and linolenic acid, docosahexaenoic acid (DHA), and mixtures thereof.

7. A method of preparing a fat composition of high purity diglyceride containing conjugated linoleic acid, the method comprising:
mixing monoglyceride, conjugated linoleic acid, and a lipase and stirring the mixture at a speed of 10 to 200 rpm; and
subjecting the stirred mixture to an transesterification at 30 60° C. under reduced pressure of 0.001 to 0.5 torr for 1 to 10 hours.

8. The method of claim 7, after the subjecting of the transesterification, further comprising performing molecular distillation on the mixture.

9. The method of claim 7, wherein the amount of conjugated linoleic acid is 1 to 80 parts by weight based on 100 parts by weight of monoglyceride and the amount of lipase is 0.1 to 20 parts by weight based on 100 parts by weight of monoglyceride.

10. The method of claim 7, wherein the lipase is selected from the group consisting of lypozyme, 1,3-positionally specific lipase, positionally non-specific lipase, 1,3-positionally specific rhizopus, or geotrios having unsaturated fatty acid specificity, more preferably 1,3-positionally specific or positionally non-specific lipase.

11. Cosmetic emulsifiers, pharmaceutical emulsifiers or highly functional food additives, comprising a fat composition of high purity diglyceride containing conjugated linoleic acid prepared by the method of claim 2 or 7.
